(19) United States
(12) Patent Application Publication
(10) Pub. No.: US 2022/0356878 A1
(43) Pub. Date: Nov. 10, 2022

(54) Reversible Reciprocating Pump

(71) Applicant: Quidnet Energy, Inc., Framingham, MA (US)

(72) Inventor: Howard K. Schmidt, Cypress, TX (US)

(73) Assignee: Quidnet Energy, Inc., Framingham, MA (US)

(21) Appl. No.: 17/623,480

(22) PCT Filed: Jun. 26, 2020
(86) PCT No.: PCT/US2020/039935

§ 371 Date: Dec. 28, 2021

Related U.S. Application Data
(63) Continuation of application No. 16/913,801, filed on Jun. 26, 2020.
(60) Provisional application No. 62/868,455, filed on Jun. 28, 2019.
(60) Provisional application No. 62/868,455, filed on Jun. 28, 2019.

(51) Int. Cl. F04C 15/06; F04B 19/02; F04B 39/00; F04B 49/035; F04B 53/10; F04C 14/04; F03C 1/00

(52) U.S. Cl. CPC F04C 15/064; F04B 19/022; F04B 39/0005; F04B 49/035; F04B 53/1087; F04C 14/04; F03C 1/00

(57) ABSTRACT

An injector generator for use in geomechanical pumped storage systems includes a power end and a fluid end. The fluid end has one or more fluid chambers each having a fluid inlet and outlet that are controlled by rotary valves. The fluid end can function as a pump or as a motor driven by fluid pressure from the geomechanical storage formation.

This application claims priority to U.S. Provisional Application Ser. No. 62/868,455 filed Jun. 28, 2019.

### BACKGROUND OF THE INVENTION

### Field of the Invention

This invention is directed to a reversible reciprocating positive displacement pump that may be incorporated for example in an energy storage system wherein fluid is pumped into previously fracked wells. The hydraulic fracture will elastically expand and store the fluid. To create energy, the fluid pressure in the well is relieved and the fluid will be directed into the reversible pump to drive a generator to produce electricity. The device may be characterized as a bi-directional injector generator (INGEN)

### Background of the Invention

Currently, reversible turbines are used for traditional pumped storage systems. These units however operate at a low pressure (100-600 psi). As such, multi-stage injection would be required, resulting in prohibitively low conversion efficiency. These units are very large and thus occupy a large footprint on location.

### BRIEF SUMMARY OF THE INVENTION

This invention is directed to a bi-directional injector-generator (INGEN) that is uniquely suited for geomechanical pumped storage (GPS) operating pressures, achieving 95% mechanical efficiency (each way), and is a homologous design series can be scaled across 0.5-10 MW. This INGEN will serve the same function as reversible turbines in traditional pumped storage facilities: consuming electricity to pump water during charging, and generating electricity from water pressure during discharge.

The need for this INGEN arises out of the fact that GPS's operating pressure of 700-2,000+ psi are well outside of the operating envelop of rotodynamic solutions (i.e., reversible turbines) that are used in traditional pumped storage facilities. Rotodynamic solutions at GPS's higher operating pressures would result in significant capex burden (separate pump and turbine), as well as RTE losses (due to pump multi-staging, which compounds pumping losses).

The INGEN is a positive-displacement machine which is better suited for the higher operating pressures. Specifically, the INGEN is built upon a plunger pump platform, with the liquid-handling end of the plunger pump modified to operate a novel bi-directional valve train. During charging, the INGEN operates like a normal plunger pump. During discharge, the INGEN operates like a reciprocating generator.

### BRIEF DESCRIPTION OF THE DRAWINGS

For a detailed description of the preferred embodiments of the invention, reference will now be made to the accompanying drawings in which:

FIG. 1 is a cross sectional view of an embodiment of an injector generator according to an embodiment of the invention in the injecting mode.

FIG. 2 is a cross sectional view of an embodiment of an injector-generator according to an embodiment of the invention in the generating mode.

FIG. 3 is a cross sectional view of one of the valve spools according to an embodiment of the invention.

FIG. 4 is a showing of a second embodiment of the invention.

FIG. 5 is a showing of a valve assembly for the embodiment of FIG. 4.

### DETAILED DESCRIPTION OF THE PREFERRED EMBODIMENTS

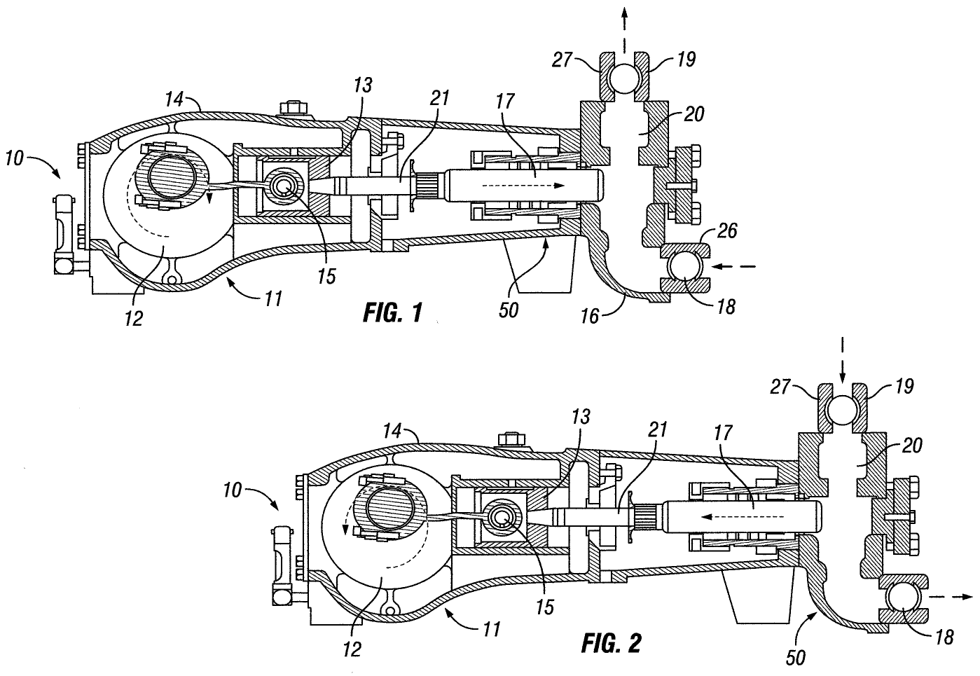

Referring to FIG. 1, an injector-generator 10 according to the invention includes a power end 11 which may be a conventional power end of a frac pump which includes a housing 14 and a drive shaft 12. Shaft 12 may be driven by any conventional power source. Reciprocating piston 13 is connected to crank shaft 12 via piston rods 15.

The fluid end 50 of the injector generator includes a housing 16. A second reciprocating piston 17 is connected to cylinder 13 via a connecting rod 21.

In the injecting mode of FIG. 1, clockwise rotation of shaft 12 will cause reciprocal movement of piston 13 and hence piston 17. Fluid will enter chamber 20 via inlet 26 on the suction stroke and will exit chamber 20 via outlet 27 on the power stroke.

Rotary valves 18 and 19 control the inlet and outlet and are connected to drive shaft 12 via a timing mechanism, for example belts or chains.

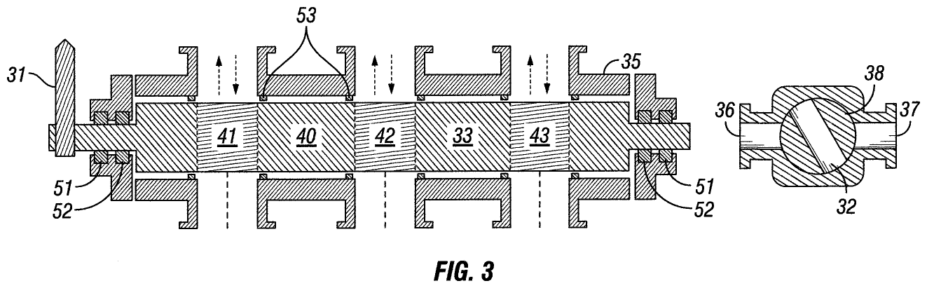

As shown in FIG. 3, the injector generator 10 may consist of three interconnected parallel sub-assemblies to create a three-piston arrangement. Two valve cylindrical assemblies as shown in FIG. 3 are connected to an inlet and outlet manifold. Each valve unit includes a cylindrical section 38 with a through bore 32 and an inlet/outlet 36, 37. A timing belt 31 connects the two valve cylindrical assemblies and drive shaft 12.

Valve assembly 40 is rotatably mounted in valve housing 35. Appropriate seals 51 and bearing 52 are provided at either end of the cylindrical assemblies. Seals 53 are located between the valve housing and assembly 40.

In the power generation mode shown in FIG. 2, fluid under pressure is introduced from the hydraulic fracture into now inlet 19. This will cause piston 17 to now act as a driving force on piston 13 which will cause drive shaft 12 to rotate. Drive shaft 12 can be connected to the drive shaft of an electrical generator.

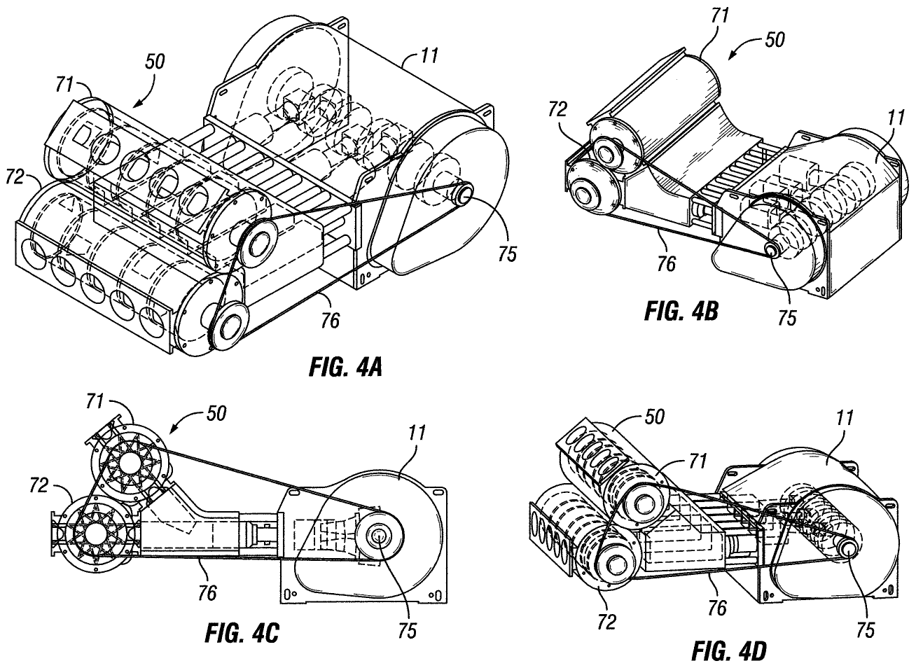

Although FIG. 3 illustrates a three cylindrical arrangement for the power and fluid ends, it is clear that the principles of the convention could be applied to an injector generator that includes any number of parallel cylinders as is known in the power and fluid sections of known frac pumps. See for example FIG. 4 which illustrates an embodiment showing five cylinders in the fluid and power ends with two valve assembles 71, 72.

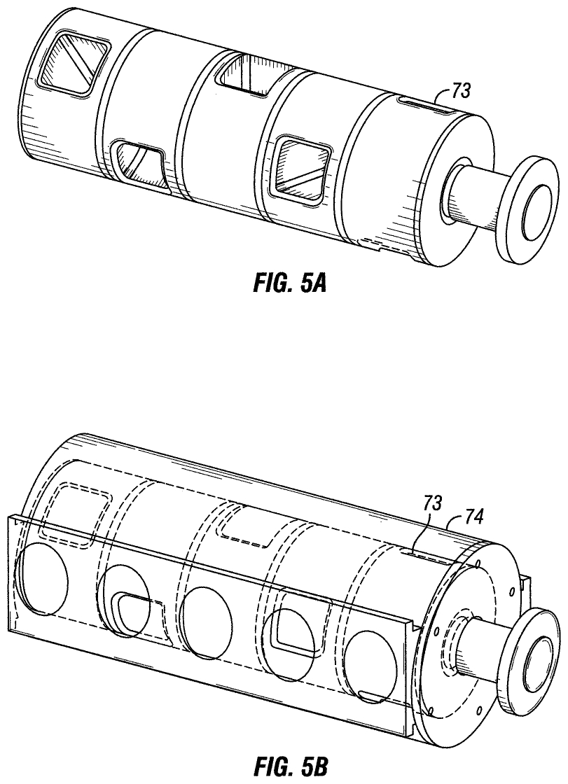

FIG. 5 illustrates the valve 73 and valve housing 74 that are adapted for use in the FIG. 4 embodiment.

Also shown in FIG. 4 is timing belt 76 which is connected to the drive shaft 75 and the valves 73.

What is claimed is:

1. A bi-directional injector generator comprising;
a) power end including a housing, a drive shaft and a reciprocating piston connected to the drive shaft,
b) a fluid end including a housing and a reciprocating piston connected to the power end reciprocating piston,
c) the fluid end including a fluid chamber having an inlet and an outlet, and
d) the inlet and outlet each including a valve controlled in a timed relationship with the drive shaft in the power end.

2. The injector generator of claim 1 wherein the fluid flow can be reversed within the fluid end to cause the injector generator to function as a motor source.

3. The injector generator of claim 1 wherein the injection generator further includes three pistons in the power end, three pistons in the fluid end, three fluid chambers in the fluid end, and two valve rotary valve assemblies, one connected to the inlets of the fluid chambers and one connected to the outlets of the fluid chambers.

4. The injector generator of claim 1 wherein the inlet and outlet valves are formed in a single valve housing which includes a dual valve element.

5. A reversible reciprocating plunger pump platform comprising;
a) a bi-directional injector generator which operates at pressures between 700-2000 psi wherein the bi-directional injector generator includes;
i. a power end including a housing, a drive shaft and a reciprocating piston connected to the drive shaft,
ii. a fluid end including a housing and a reciprocating piston connected to the power end reciprocating piston,
iii. the fluid end including a fluid chamber having an inlet and an outlet, and
iv. the inlet and outlet each including a valve controlled in a timed relationship with the drive shaft in the power end.

6. The injector generator of claim 5 wherein the fluid flow can be reversed within the fluid end to cause the injector generator to function as a motor source.

7. The injector generator of claim 5 wherein the injection generator further includes three pistons in the power end, three pistons in the fluid end, three fluid chambers in the fluid end, and two valve rotary valve assemblies, one connected to the inlets of the fluid chambers and one connected to the outlets of the fluid chambers.

8. The injector generator of claim 5 wherein the inlet and outlet valves are formed in a single valve housing which includes a dual valve element.

9. A method of producing electricity comprising:
a. incorporating a bi-directional injection generator in an energy storage system wherein fluid is pumped into a previously fracked well.
b. utilizing the pressure of fluid pumped into the previously fracked well to drive the bi-directional injection generator including:
e) a power end including a housing, a drive shaft and a reciprocating piston connected to the drive shaft,
f) a fluid end including a housing and a reciprocating piston connected to the power end reciprocating piston,
g) the fluid end including a fluid chamber having an inlet and an outlet, and
h) the inlet and outlet each including a valve controlled in a timed relationship with the drive shaft in the power end.

10. The method of claim 9 wherein the fluid flow can be reversed within the fluid end to cause the injector generator to function as a motor source.

11. The method of claim 9 wherein the injector generator further includes three pistons in the power end, three pistons in the fluid end, three fluid chambers in the fluid end, and two valve rotary valve assemblies, one connected to the inlets of the fluid chambers and one connected to the outlets of the fluid chambers.

12. The method of claim 9 wherein the inlet and outlet valves are formed in a single valve housing which includes a dual valve element.

13. The method of claim 9 wherein the bi-directional injector generator operates at a fluid pressure range between 700 and 2000 psi.
